(19) United States
(12) Patent Application Publication
(10) Pub. No.: US 2026/0302183 A1
(43) Pub. Date: Oct. 1, 2026

(54) ELECTROCHEMICAL APPARATUS AND ELECTRONIC DEVICE

(71) Applicant: Ningde Amperex Technology Limited, Ningde (CN)

(72) Inventor: Gongqian TAN, Ningde (CN)

(73) Assignee: Ningde Amperex Technology Limited, Ningde (CN)

(21) Appl. No.: 19/574,466

(22) Filed: Mar. 23, 2026

(30) Foreign Application Priority Data
Mar. 27, 2025 (CN) 202510376435.4

(51) Int. Cl. H01M 4/36; H01M 4/02; H01M 4/62; H01M 4/66

(52) U.S. Cl. CPC H01M 4/364; H01M 4/621; H01M 4/66; H01M 2004/028

(57) ABSTRACT

An electrochemical apparatus includes a cathode electrode plate, a separator, and an anode electrode plate. The separator is disposed between the cathode electrode plate and the anode electrode plate. The anode electrode plate includes silicon element. The cathode electrode plate includes a first current collector, a protective layer, and a first material layer. The protective layer is disposed between the first current collector and the first material layer. The first current collector includes a first substrate layer, a first conductive layer, and a second conductive layer. The first substrate layer is disposed between the first conductive layer and the second conductive layer. The first material includes lithium element. Each of the first conductive layer and the second conductive layer has a thickness of H micrometers, and the protective layer has a thickness of B micrometers, wherein 2/H≤B≤4.

### CROSS-REFERENCE TO RELATED APPLICATION

This application claims priority to the Chinese Patent Application Serial No. 202510376435.4, filed on Mar. 27, 2025, the content of which is incorporated herein by reference in its entirety.

### TECHNICAL FIELD

Some embodiments of this application relate to the field of battery technologies, and in particular, to an electrochemical apparatus and an electronic device.

### BACKGROUND

With the rapid development of modern technology, the demand for high-performance energy storage apparatuses in fields such as portable electronic devices and electric vehicles is increasingly high. As an efficient and environmentally friendly energy storage apparatus, lithium-ion batteries have been widely used in numerous fields due to their advantages such as high energy density, long cycle life, and low self-discharge rate. In the continuous development process of lithium-ion batteries, the requirements for the safety performance of the batteries are also becoming increasingly high.

### SUMMARY

One objective of an embodiment of this application is to provide an electrochemical apparatus and an electronic device, capable of improving the safety performance of the electrochemical apparatus.

According to a first aspect, an embodiment of this application provides an electrochemical apparatus including an electrode assembly, where the electrode assembly includes a cathode electrode plate, a separator, and an anode electrode plate; the separator is disposed between the cathode electrode plate and the anode electrode plate; the anode electrode plate includes silicon element; the cathode electrode plate includes a first current collector, a protective layer, and a first material layer, where along a thickness direction of the electrode assembly, the protective layer is disposed on a surface of the first current collector, and the first material layer is disposed on a surface of the protective layer facing away from the first current collector; the first current collector includes a first substrate layer, a first conductive layer, and a second conductive layer, where the first substrate layer is disposed between the first conductive layer and the second conductive layer, and the first substrate layer includes at least one of polyethylene terephthalate, polyimide, polyamide, polyurethane, polyethylene, or polypropylene; the first material layer includes a first material and a second material, the first material including lithium element; and each of the first conductive layer and the second conductive layer has a thickness of H micrometers, the protective layer has a thickness of B micrometers, and a mass percentage of the first material in the first material layer is C %, wherein 2/H≤B≤4.

In this embodiment of this application, the protective layer is disposed between the first current collector and the first material layer, so that the protective layer can protect at least one surface of the first current collector, thereby reducing the risk of mechanical damage to the first current collector and further reducing the risk of burrs or protrusions generated at the damaged position of the first current collector piercing the separator and causing a short circuit between the cathode electrode plate and the anode electrode plate. In addition, the first current collector includes the first substrate layer, and the first substrate layer includes at least one of polyethylene terephthalate, polyimide, polyamide, polyurethane, polyethylene, or polypropylene. The first substrate layer has a high elongation rate, so that the cathode electrode plate can extend when subjected to pressure, and the first substrate layer can rapidly extend under mechanical stress to significantly increase the sheet resistance of the first current collector, thereby increasing the resistance during short circuit, reducing heat generation during short circuit, and further improving the safety performance of the electrochemical apparatus. On this basis, the anode electrode plate includes silicon element, which provides a high theoretical specific capacity for the electrochemical apparatus, thereby increasing the capacity of the electrochemical apparatus. In addition, the first material in this application is combined to perform lithium supplementation on the cathode electrode plate, thereby reducing the loss of energy density caused by the low first-cycle efficiency of a silicon negative electrode, improving the safety performance of the electrochemical apparatus, and increasing the energy density of the electrochemical apparatus. Furthermore, setting 2/H≤B≤4 can improve the safety performance of the electrochemical apparatus and guarantee the energy density and the number of cycles of the electrochemical apparatus.

In some embodiments, the first material includes at least one of Li₅₋ₓFeO_{4-y}, Li₆₋ₓCoO_{4-y}, Li_{2-z}MnO₂, or Li_{1.2-r}Ni_{0.13}Fe_{0.13}Mn_{0.54}O₂, where 4≤x≤5, 2≤y≤4, 1.6≤z≤2, and 0.2≤r≤1.2; and a mass percentage of the first material in the first material layer is C %, and B≤2*C. This can further increase the energy density of the electrochemical apparatus.

In some embodiments, 1≤H≤3. Preferably, 1.5≤H≤2. If the thickness of the first conductive layer or the second conductive layer is too small, the sheet resistance of the cathode electrode plate 1 is too high, the internal resistance of the electrochemical apparatus is too high, and the electrical performance of the electrochemical apparatus is poor. If the thickness of the first conductive layer or the second conductive layer is too large, on the one hand, the energy density of the electrochemical apparatus is reduced; on the other hand, an excessively thick conductive layer is prone to formation of large-sized burrs during piercing or squeezing, and the separator is easily pierced, resulting in a short circuit. Therefore, setting 1≤H≤3 can reduce the internal resistance of the electrochemical apparatus, improve the kinetic performance of the electrochemical apparatus, guarantee the energy density of the electrochemical apparatus, and improve the safety performance of the electrochemical apparatus.

In some embodiments, 1≤B≤4. Preferably, 1.5≤B≤2.5. If the thickness of the protective layer is too small, the protective effect on the first current collector is insufficient, and the first current collector is easily pierced by a cathode main material during cold pressing, posing risks of lithium precipitation and safety. In addition, if the thickness of the protective layer is too small, the sheet resistance is high, the conductivity is poor, a charging speed is deteriorated, and the charging temperature rise is deteriorated, which is unfavorable to the performance of the electrochemical apparatus. If the thickness of the protective layer is too large, the energy density of the electrochemical apparatus is affected. Therefore, setting 1.5≤B≤2.5 can improve the protective effect of the protective layer on the first current collector, reduce the risk of mechanical damage to the first current collector, and guarantee the energy density of the electrochemical apparatus.

In some embodiments, 0.5%≤C %≤4%. Preferably, 1%≤C %≤3%. If the percentage of the first material is too low, the lithium supplementation amount of the cathode electrode plate 1 is low, resulting in low energy density of the electrochemical apparatus. Side reactions of the first material are more than side reactions of the second material. If the percentage of the first material is too high, side reactions are likely to increase significantly, deteriorating the cyclic charge-discharge capability of the electrochemical apparatus and deteriorating the electrical performance of the electrochemical apparatus 100 at a high temperature. Therefore, setting 0.5%≤C %≤4% can improve the cyclic charge-discharge capability of the electrochemical apparatus, improve the high-temperature performance, and guarantee the energy density of the electrochemical apparatus.

In some embodiments, along the thickness direction of the electrode assembly, the protective layer is disposed on each of two opposite surfaces of the first current collector, and the first material layer is disposed on the surface of the protective layer facing away from the first current collector.

In this embodiment, the protective layer is disposed on each of two surfaces of the first current collector 11, so that two sides of the first current collector 11 can be protected, helping to further reduce the risk of mechanical damage to the first current collector, thereby reducing the risk of protrusions generated at the damaged position of the first current collector piercing the separator and causing a short circuit.

In some embodiments, the second material includes at least one of lithium cobalt oxide, lithium nickel cobalt manganese oxide, lithium nickel cobalt aluminum oxide, lithium iron phosphate, or lithium manganese oxide.

In some embodiments, the protective layer includes an inorganic material, a conductive agent, and a binder. The conductive agent can enhance the conductivity of the first material layer. The binder is used to bond particles in the inorganic material and the conductive agent and to bond the first material layer to the first conductive layer or the second conductive layer.

In some embodiments, the binder includes at least one of metal polyacrylate, polyvinylidene fluoride, or styrene-butadiene rubber.

In some embodiments, the inorganic material includes at least one of aluminum oxide, boehmite, titanium dioxide, barium titanate, or barium sulfate.

In some embodiments, the anode electrode plate includes a second current collector and a second material layer, where the second material layer is disposed on at least one surface of the second current collector, the second material layer includes silicon element, and a mass percentage of silicon element in the second material layer is D %, and 1%≤D %≤50%. Increasing the percentage of silicon element can increase the energy density of the electrochemical apparatus, but silicon is prone to expansion during intercalation or deintercalation of lithium ions, resulting in an increase in the volume of the electrochemical apparatus. Therefore, setting 1%≤D %≤50% can increase the energy density of the electrochemical apparatus and reduce volume expansion.

In some embodiments, a specific charge capacity of the first material is E, and a specific charge capacity of the second material is F, and F<E. Such arrangement helps to increase the energy density of the electrochemical apparatus.

In some embodiments, 240 mAh/g≤E≤950 mAh/g. Such arrangement helps to increase the energy density of the electrochemical apparatus.

According to a second aspect, this application provides an electronic device including the above electrochemical apparatus.

The beneficial effects of these embodiments of this application are as follows: the protective layer is disposed between the first current collector and the first material layer, so that the protective layer can protect at least one surface of the first current collector, thereby reducing the risk of mechanical damage to the first current collector and further reducing the risk of burrs or protrusions generated at the damaged position of the first current collector piercing the separator and causing a short circuit between the cathode electrode plate and the anode electrode plate. In addition, the first current collector includes the first substrate layer which includes at least one of polyethylene terephthalate, polyimide, polyamide, polyurethane, polyethylene, or polypropylene. The first substrate layer has a high elongation rate, so that the cathode electrode plate can extend when subjected to pressure, and the first substrate layer can rapidly extend under mechanical stress to significantly increase the sheet resistance of the first current collector, thereby increasing the resistance during short circuit, reducing heat generation during short circuit, and further improving the safety performance of the electrochemical apparatus. On this basis, the anode electrode plate includes silicon element, which provides a high theoretical specific capacity for the electrochemical apparatus, thereby increasing the capacity of the electrochemical apparatus. In addition, the first material in this application is combined to perform lithium supplementation on the cathode electrode plate, thereby reducing the loss of energy density caused by the low first-cycle efficiency of a silicon negative electrode, improving the safety performance of the electrochemical apparatus, and increasing the energy density of the electrochemical apparatus. Furthermore, setting 2/H≤B≤4 and B≤2*C can further improve the safety performance and energy density of the electrochemical apparatus.

### BRIEF DESCRIPTION OF DRAWINGS

One or more embodiments are illustratively described by means of the pictures in the corresponding drawings thereof, and these illustrative descriptions do not constitute any limitation to these embodiments. Elements in the drawings having the same reference numerals are denoted as similar elements.

FIG. 1 is a schematic structural diagram of an electrode assembly according to an embodiment of this application;

FIG. 2 is a schematic structural diagram of an electrochemical apparatus according to an embodiment of this application; and

FIG. 3 is a schematic diagram of a partial structure of an electrode assembly according to an embodiment of this application.

### DESCRIPTION OF REFERENCE SIGNS

100. electrochemical apparatus;
10. electrode assembly;
1. cathode electrode plate; 11. first current collector; 111. first substrate layer; 112. first conductive layer; 113. second conductive layer; 12. protective layer; 13. first material layer;
2. separator;
3. anode electrode plate; 31. second current collector; 311. second substrate layer; 312. third conductive layer; 313. fourth conductive layer; and 32. second material layer.

### DETAILED DESCRIPTION

To make the objectives, technical solutions, and advantages of some embodiments of this application clearer, the technical solutions in these embodiments of this application will be clearly and completely described below in conjunction with the drawings in these embodiments of this application. Apparently, the described embodiments are some rather than all of these embodiments of this application. It should be understood that the specific embodiments described herein are only used to explain this application and are not used to limit this application.

It should be noted that when an element is expressed as being “connected” to another element, it can be directly connected to the another element or one or more intermediate elements may exist therebetween. In addition, the technical features involved in the various embodiments of this application described below can be combined with each other as long as they do not conflict with each other.

Silicon materials have a high theoretical specific capacity. When applied in an anode electrode plate, the theoretical specific capacity of the silicon materials is typically dozens of times that of graphite negative electrode materials. Therefore, electrochemical apparatuses containing silicon materials applied in anode electrode plates are becoming increasingly popular in the market.

However, silicon materials undergo significant expansion during charge and discharge processes, resulting in an increase in the volume of the electrochemical apparatus, thereby reducing the energy density. In addition, in the related art, in an electrochemical apparatus under a silicon system, a cathode electrode plate typically includes a cathode electrode plate current collector and a cathode electrode plate active material layer. The cathode electrode plate current collector is typically an aluminum foil, and the cathode electrode plate active material layer is disposed on at least one surface of the aluminum foil. However, when the electrochemical apparatus is subjected to mechanical damage, the aluminum foil is easily pierced, resulting in a short circuit with an anode electrode plate. The safety performance of the electrochemical apparatus is low.

To solve at least some of the above problems, according to a first aspect, this application provides an electrochemical apparatus. A protective layer is disposed between a first current collector and a first material layer, thereby reducing the risk of mechanical damage (for example, being pierced) to a cathode electrode plate and further reducing the risk of short circuit caused by contact between the cathode electrode plate and an anode electrode plate due to mechanical damage to the cathode electrode plate.

The specific solution of this application is described in detail below.

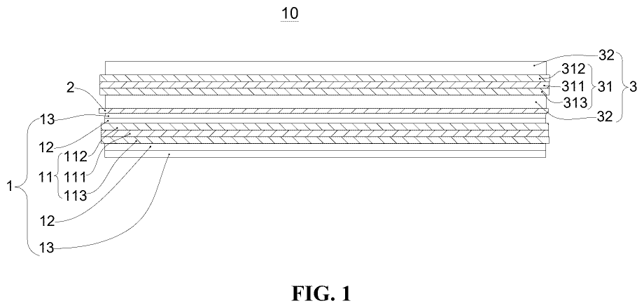

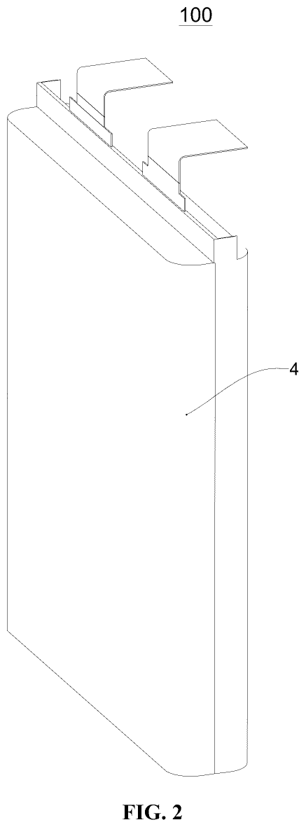

Referring to FIG. 1 and FIG. 2, an electrochemical apparatus 100 includes an electrode assembly 10. The electrode assembly 10 includes an anode electrode plate 3, a separator 2, and a cathode electrode plate 1. The separator 2 is disposed between the anode electrode plate 3 and the cathode electrode plate 1. The anode electrode plate 3 includes silicon element.

In some embodiments, the electrochemical apparatus 100 includes a shell 4. The electrode assembly 10 is accommodated in the shell 4, so that the shell 4 can protect the electrode assembly 10.

In some embodiments, the anode electrode plate 3 includes a second current collector 31 and a second material layer 32. The second material layer 32 is disposed on a surface of the second current collector 31. The second material layer 32 includes silicon element.

It is worth noting that the second material layer 32 includes silicon element or the anode electrode plate 3 includes silicon element, where “include” means that the second material layer 32 includes a silicon-containing material such as pure silicon, silicon oxide, or silicon carbon. The silicon-containing material serves as a main carrier for intercalation or deintercalation of lithium ions, rather than existing in the second material layer 32 or the anode electrode plate 3 in the form of impurities.

In some embodiments, the second current collector 31 may be a copper foil.

It can be understood that the second current collector 31 may alternatively be a composite current collector, that is, the second current collector 31 includes a second substrate layer 311, a third conductive layer 312, and a fourth conductive layer 313. The third conductive layer 312 and the fourth conductive layer 313 are respectively disposed on two sides of the second substrate layer 311. A surface of the third conductive layer 312 facing away from the second substrate layer 311 and a surface of the fourth conductive layer 313 facing away from the second substrate layer 311 may each be provided with the second material layer 32.

In some embodiments, a mass percentage of silicon element in the second material layer 32 is D %, and 1%≤D %≤50%. In some embodiments, the value of D may be 1, 3, 5, 8, 10, 13, 15, 18, 20, 23, 25, 28, 30, 33, 35, 38, 40, 43, 45, 48, 50, a range formed by any two of these values, or a value within a range formed by any two of these values. Increasing the percentage of silicon element can increase the energy density of the electrochemical apparatus 100, but silicon is prone to expansion during intercalation or deintercalation of lithium ions, resulting in an increase in the volume of the electrochemical apparatus 100. Therefore, setting 1%≤D %≤50% can increase the energy density of the electrochemical apparatus 100 and reduce volume expansion.

The electrochemical apparatus 100 may be provided in a wound form, that is, after the separator 2 is disposed between the anode electrode plate 3 and the cathode electrode plate 1, the anode electrode plate 3, the separator 2, and the cathode electrode plate 1 are wound and formed.

The electrochemical apparatus 100 may alternatively be provided in a laminated form, that is, the anode electrode plate 3, the separator 2, and the cathode electrode plate 1 are alternately laminated, with the separator 2 disposed between the anode electrode plate 3 and the cathode electrode plate 1. The separator 2 is used for electrical isolation between the anode electrode plate 3 and the cathode electrode plate 1, reducing the risk of short circuit of the electrochemical apparatus 100. A stacking direction of the anode electrode plate 3, the separator 2, and the cathode electrode plate 1 is a thickness direction of the electrode assembly 10.

In some embodiments, the anode electrode plate 3, the separator 2, and the cathode electrode plate 1 may be provided in plurality. The plurality of anode electrode plates 3, the plurality of separators 2, and the plurality of cathode electrode plates 1 are alternately laminated in sequence, where one separator 2 is disposed between one anode electrode plate 3 and one cathode electrode plate 1.

In this application, a laminated electrochemical apparatus 100 is used as an example for description.

Referring to FIG. 1, the cathode electrode plate 1 includes a first current collector 11, a protective layer 12, and a first material layer 13. Along the thickness direction of the electrode assembly 10, the protective layer 12 is disposed on a surface of the first current collector 11, and the first material layer 13 is disposed on a surface of the protective layer 12 facing away from the first current collector 11. The first current collector 11 includes a first conductive layer 112, a first substrate layer 111, and a second conductive layer 113. The first substrate layer 111 is disposed between the first conductive layer 112 and the second conductive layer 113, that is, the first conductive layer 112 and the second conductive layer 113 are respectively disposed on two opposite surfaces of the first substrate layer 111. The first material layer 13 is disposed on a surface of the first conductive layer 112 facing away from the first substrate layer 111, or the first material layer 13 is disposed on a surface of the second conductive layer 113 facing away from the first substrate layer 111. The first material layer 13 includes a first material and a second material. The first material and the second material are mixed with each other. The first material includes lithium element. In some embodiments, the first material includes at least one of Li₅₋ₓFeO_{4-y}, Li₆₋ₓCoO_{4-y}, Li_{2-z}MnO₂, or Li_{1.2-r}Ni_{0.13}Fe_{0.13}Mn_{0.54}O₂, where 4≤x≤5, 2≤y≤4, 1.6≤z≤2, and 0.2≤r≤1.2. A silicon-based negative electrode material generates a large number of SEI (Solid Electrolyte Interface, solid electrolyte) films during an initial charging process, consuming a large amount of active lithium, resulting in low first-cycle coulombic efficiency and low battery energy density. The first material can serve as a lithium supplementation agent to supplement lithium ions in the cathode electrode plate 1, thereby increasing the battery capacity and energy density of the electrochemical apparatus 100, replacing the consumption of active lithium as a cathode main material, and improving the utilization rate of the cathode main material. In addition, the protective layer 12 can reduce the risk of mechanical damage to the first current collector 11. When the first current collector 11 after damaged generates sharp protrusions that pierce the separator 2 and comes into contact with the anode electrode plate 3, the first current collector 11 is insulated from the anode electrode plate 3, reducing the risk of short circuit of the electrochemical apparatus 100 and improving the safety performance of the electrochemical apparatus 100.

In some embodiments, the second material includes at least one of lithium cobalt oxide, lithium nickel cobalt manganese oxide, lithium nickel cobalt aluminum oxide, lithium iron phosphate, or lithium manganese oxide.

In some embodiments, the first material and the second material are mixed with each other. The mixing method has a simple process and low cost.

It is worth noting that a particle size of the second material is large (typically greater than 5 μm), while a particle size of the first material is small. The first material is mixed with the second material, so that when the cathode electrode plate 1 is cold-pressed, the first material can fill gaps between particles of the second material, making the pressure more uniform, thereby reducing the risk of large-particle-size particles (for example, lithium cobalt oxide particles) in the second material piercing the first current collector 11, and helping to reduce the risk of lithium precipitation at the pierced position of the electrochemical apparatus 100.

Further, the impedance of the protective layer 12 is greater than the impedance of the first conductive layer 112 and the second conductive layer 113. Therefore, even if the first current collector 11 undergoes mechanical damage and comes into contact with the anode electrode plate 3 to cause a short circuit, the Joule heat generated by the short circuit can be significantly reduced, thereby reducing the probability of failure of the electrochemical apparatus 100 and further improving the safety performance of the electrochemical apparatus 100.

In some embodiments, the first substrate layer 111 is made of at least one material selected from polyethylene terephthalate, polyimide, polyamide, polyurethane, polyethylene, or polypropylene. That is, the first substrate layer 111 is made of a polymer material. Therefore, the first substrate layer 111 has high resistance, and the first substrate layer 111 has a high elongation rate. Especially under high elongation, the resistance of the first substrate layer 111 increases exponentially, that is, the sheet resistance of the first current collector 11 is increased. Even if a short circuit occurs, the Joule heat generated by the short circuit can be reduced, thereby further improving the safety performance of the electrochemical apparatus 100.

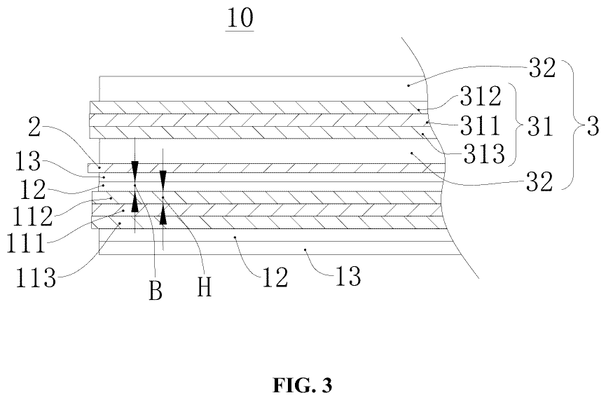

In some embodiments, referring to FIG. 3, each of the first conductive layer 112 and the second conductive layer 113 has a thickness of H micrometers, and the protective layer 12 has a thickness of B micrometers, wherein 2/H≤B≤4. In some embodiments, a mass percentage of the first material in the first material layer 13 is C %, and B≤2*C. If the thickness of the protective layer 12 is too small, the protective effect on the first current collector 11 is insufficient, and the first current collector 11 is easily pierced by a cathode main material during cold pressing, posing risks of lithium precipitation and safety. In addition, if the thickness of the protective layer 12 is too small, the protective effect on the cathode current collector during mechanical safety testing is insufficient, the internal short-circuit impedance is small, and the risk of fire and explosion is high. If the thickness of the protective layer 12 is too large, the energy density of the electrochemical apparatus 100 is affected. In addition, if the thickness of the protective layer 12 is too large, the sheet resistance is high, the conductivity is poor, a charging speed is deteriorated, and the charging temperature rise is deteriorated, which is unfavorable to the performance of the electrochemical apparatus. Therefore, setting 2/H≤B≤4 and B≤2*C can improve the protective capability of the protective layer 12 on the first current collector 11, thereby improving the safety performance of the electrochemical apparatus 100 and guaranteeing the energy density of the electrochemical apparatus 100.

In some embodiments, 3/H≤B≤3. Setting 3/H≤B can further improve the protective capability of the protective layer 12 on the first current collector 11 and further improve the safety performance of the electrochemical apparatus 100. Setting B≤3 can further increase the energy density of the electrochemical apparatus 100 and extend the service life of the electrochemical apparatus 100.

In some embodiments, B≤C. The content of the lithium supplementation agent can be increased to further increase the energy density of the electrochemical apparatus 100.

In some embodiments, each of the first conductive layer 112 and the second conductive layer 113 is made of metal. The metal material has good conductivity, which helps to improve the charge-discharge performance of the electrochemical apparatus 100.

In some embodiments, the first conductive layer 112 and the second conductive layer 113 have equal thicknesses. Inconsistent thicknesses of the first conductive layer 112 and the second conductive layer 113 easily lead to uneven current distribution inside the electrochemical apparatus 100, thereby reducing the charge-discharge rate of the electrochemical apparatus 100. Limiting the thicknesses of the first conductive layer 112 and the second conductive layer 113 to be equal helps to improve the uniformity of the current inside the electrochemical apparatus 100 and increase the charge-discharge rate of the electrochemical apparatus 100. It can be understood that, without affecting the objective of this application, due to production and processing accuracy and other reasons, when a difference between the thickness of the first conductive layer 112 and the thickness of the second conductive layer 113 does not exceed 10%, the thicknesses of the first conductive layer 112 and the second conductive layer 113 can also be considered to be equal.

In some embodiments, the first conductive layer 112 or the second conductive layer 113 has a thickness of H micrometers, and 0.5≤H≤4, preferably 1≤H≤3. In some embodiments, H may be 0.5, 0.8, 0.9, 1, 1.2, 1.5, 1.8, 2, 2.2, 2.4, 2.8, 3, 3.2, 3.4, 3.6, 3.8, 4, a range formed by any two of these values, or a value within a range formed by any two of these values. If the thickness of the first conductive layer 112 or the second conductive layer 113 is too small, the sheet resistance of the cathode electrode plate 1 is too high, the internal resistance of the electrochemical apparatus 100 is too high, and the electrical performance of the electrochemical apparatus 100 is poor. If the thickness of the first conductive layer 112 or the second conductive layer 113 is too large, on the one hand, the energy density of the electrochemical apparatus 100 is reduced; on the other hand, an excessively thick conductive layer is prone to formation of large-sized burrs during piercing or squeezing, and the separator 2 is easily pierced, resulting in a short circuit. Therefore, setting 1≤H≤3 can reduce the internal resistance of the electrochemical apparatus 100, improve the kinetic performance of the electrochemical apparatus 100, guarantee the energy density of the electrochemical apparatus 100, improve the safety performance of the electrochemical apparatus 100, and reduce the risk of the cathode electrode plate 1 being pierced during cold pressing, thereby reducing the risk of lithium precipitation in the electrochemical apparatus 100.

Further, the thickness of the first conductive layer 112 or the second conductive layer 113 satisfies: 1.5≤H≤2. Setting 1.5≤H can further reduce the internal resistance of the electrochemical apparatus 100, increase the energy density of the electrochemical apparatus 100, and further reduce the risk of the cathode electrode plate 1 being pierced during cold pressing, thereby reducing the risk of lithium precipitation in the electrochemical apparatus 100. Setting H≤2 can further improve the energy density and safety performance of the electrochemical apparatus 100.

In some embodiments, the protective layer 12 has a thickness of B micrometers, satisfying: 0.5≤B≤4.5, preferably 1≤B≤4. In some embodiments, the value of B may be 0.5, 0.8, 1, 1.2, 1.4, 1.5, 1.8, 2, 2.2, 2.4, 2.5, 2.7, 2.9, 3, 3.2, 3.4, 3.5, 3.7, 3.9, 4, 4.3, 4.5, a range formed by any two of these values, or a value within a range formed by any two of these values. If the thickness of the protective layer 12 is too small, the protective effect on the first current collector 11 is insufficient, and the first current collector 11 is easily pierced by the cathode main material during cold pressing, posing risks of lithium precipitation and safety. In addition, if the thickness of the protective layer 12 is too small, the protective effect on the cathode current collector during mechanical safety testing is insufficient, the internal short-circuit impedance is small, and the risk of fire and explosion is high. If the thickness of the protective layer 12 is too large, the energy density of the electrochemical apparatus 100 is affected. In addition, if the thickness of the protective layer 12 is too large, the sheet resistance is high, the conductivity is poor, the charging speed is deteriorated, and the charging temperature rise is deteriorated, which is unfavorable to the performance of the electrochemical apparatus. Therefore, setting 1≤B≤4 can improve the protective effect of the protective layer 12 on the first current collector 11, reduce the risk of mechanical damage to the first current collector 11, guarantee the energy density of the electrochemical apparatus 100, and extend the service life of the electrochemical apparatus 100.

Further, 1.5≤B≤2.5. Setting 1.5≤B can further increase a pass rate of nail penetration test, thereby improving the safety performance of the electrochemical apparatus and further extending the service life. Setting B≤2.5 helps to further increase the energy density of the electrochemical apparatus.

In some embodiments, a mass percentage of the first material in the first material layer 13 is C %, and 0.5%≤C %≤4%, preferably 1%≤C %≤3%. In some embodiments, the value of C may be 0.5, 0.8, 1, 1.2, 1.5, 1.7, 2, 2.2, 2.5, 2.7, 3, 3.2, 3.5, 3.7, 4, a range formed by any two of these values, or a value within a range formed by any two of these values. If the percentage of the first material is too low, the lithium supplementation amount of the cathode electrode plate 1 is low, resulting in low energy density of the electrochemical apparatus 100. Side reactions of the first material are more than side reactions of the second material. If the percentage of the first material is too high, side reactions are likely to increase significantly, deteriorating the cyclic charge-discharge capability of the electrochemical apparatus 100 and deteriorating the electrical performance of the electrochemical apparatus 100 at a high temperature. Therefore, setting 0.5%≤C %≤4% can improve the cyclic charge-discharge capability of the electrochemical apparatus 100, improve the high-temperature performance, extend the service life of the electrochemical apparatus 100, guarantee the energy density of the electrochemical apparatus 100, and reduce the risk of the cathode electrode plate 1 being pierced during cold pressing.

Further, the mass percentage of the first material in the first material layer 13 satisfies: 1%≤C %≤3%. Setting 1%≤C % can further increase the energy density of the electrochemical apparatus 100 and further extend the service life of the electrochemical apparatus. Setting C %≤3% can further improve the cyclic charge-discharge capability of the electrochemical apparatus 100, improve the high-temperature performance, help to further reduce the risk of the cathode electrode plate being pierced during cold pressing, and further improve the safety performance of the electrochemical apparatus.

Further, the mass percentage of the first material in the first material layer 13 satisfies: 1.5%≤C %≤2.5%. Setting 1.5%≤C % can further increase the energy density of the electrochemical apparatus 100. Setting C %≤2.5% can further improve the cyclic charge-discharge capability of the electrochemical apparatus 100 and improve the high-temperature performance.

In some embodiments, referring to FIG. 1, along the thickness direction of the electrode assembly 10, the protective layer 12 is disposed on each of two opposite surfaces of the first current collector 11, and the first material layer 13 is disposed on the surface of the protective layer 12 facing away from the first current collector 11. In these embodiments, the protective layer 12 is provided on each of both surfaces of the first current collector 11, so that two sides of the first current collector 11 can be protected, helping to further reduce the risk of mechanical damage to the first current collector 11, thereby reducing the risk of protrusions generated at the damaged position of the first current collector 11 piercing the separator 2 and causing a short circuit.

In some embodiments, the first material layer 13 may be disposed on a surface of one of the protective layers 12 facing away from the first current collector 11, or the above first material layer 13 may be disposed on the surface of each of two protective layers 12 facing away from the first current collector 11. That is, the cathode electrode plate 1 may be provided with an active material on only one side or on both sides. This is not limited in this application.

In some embodiments, the protective layer 12 includes an inorganic material, a conductive agent, and a binder. The conductive agent can enhance the conductivity of the first material layer 13. The binder is used to bond particles in the inorganic material and the conductive agent and to bond the first material layer 13 to the first conductive layer 112 or the second conductive layer 113.

In some embodiments, the binder includes at least one of metal polyacrylate, polyvinylidene fluoride, or styrene-butadiene rubber.

In some embodiments, the above inorganic material includes at least one of aluminum oxide, boehmite, titanium dioxide, barium titanate, or barium sulfate.

In some embodiments, a specific charge capacity of the first material is E, and a specific charge capacity of the second material is F, and F<E. Such arrangement helps to increase the energy density of the electrochemical apparatus 100.

In some embodiments, 240 mAh/g≤E≤1000 mAh/g, preferably 240 mAh/g≤E≤950 mAh/g. In some embodiments, E may be 240 mAh/g, 250 mAh/g, 300 mAh/g, 350 mAh/g, 400 mAh/g, 450 mAh/g, 500 mAh/g, 550 mAh/g, 600 mAh/g, 650 mAh/g, 700 mAh/g, 750 mAh/g, 800 mAh/g, 850 mAh/g, 900 mAh/g, 950 mAh/g, 1000 mAh/g, a range formed by any two of these values, or a value within a range formed by any two of these values. Such arrangement helps to increase the energy density of the electrochemical apparatus 100.

In some embodiments, 300 mAh/g≤E≤700 mAh/g, thereby further increasing the energy density of the electrochemical apparatus 100.

In these embodiments of this application, the protective layer 12 is disposed between the first current collector 11 and the first material layer 13, so that the protective layer 12 can protect at least one surface of the first current collector 11, thereby reducing the risk of mechanical damage to the first current collector 11 and further reducing the risk of burrs or protrusions generated at the damaged position of the first current collector 11 piercing the separator 2 and causing a short circuit between the cathode electrode plate 1 and the anode electrode plate 3. In addition, the first current collector 11 includes a first substrate layer 111 including at least one of polyethylene terephthalate, polyimide, polyamide, polyurethane, polyethylene, or polypropylene. The first substrate layer 111 has a high elongation rate, so that the cathode electrode plate 1 can extend when subjected to pressure, and the first substrate layer 111 can rapidly extend under mechanical stress to significantly increase the sheet resistance of the first current collector 11, thereby increasing the resistance during short circuit, reducing heat generation during short circuit, and further improving the safety performance of the electrochemical apparatus 100. On this basis, the anode electrode plate 3 includes silicon element, which provides a high theoretical specific capacity for the electrochemical apparatus 100, thereby increasing the capacity of the electrochemical apparatus 100. In addition, the first material in this application is combined to perform lithium supplementation on the cathode electrode plate 1, thereby reducing the loss of energy density caused by the low first-cycle efficiency of a silicon negative electrode, improving the safety performance of the electrochemical apparatus 100, and increasing the energy density of the electrochemical apparatus 100. Furthermore, setting 2/H≤B≤4 and B≤2*C can further improve the safety performance and energy density of the electrochemical apparatus 100.

According to a second aspect, this application provides an electronic device. The electronic device includes the above electrochemical apparatus. For the specific structure and function of the electrochemical apparatus, reference is made to the above embodiments, which are not described herein again.

To enable readers to better understand the concept of this application, experimental verification is performed below.

The preparation of the electrochemical apparatus in Example 1 was as follows:

### <Preparation of Cathode Electrode Plate>

An inorganic material aluminum oxide, a conductive agent sodium polyacrylate, and a conductive agent conductive carbon black were mixed at a mass ratio of 88:10:2, and water was added as a solvent. The resulting mixture was stirred well in a vacuum mixer to obtain a protective layer slurry with a solid content of 50 wt %. The protective layer slurry was uniformly applied on surfaces of both sides of a first current collector. The first current collector was a composite current collector, and the first current collector is a current collector including a first conductive layer, a polymer layer, and a second conductive layer. The polymer layer was made of polyethylene terephthalate. Both the first conductive layer and the second conductive layer were made of aluminum. Drying was performed at 120° C. A cathode electrode plate with protective layers applied on both surfaces was obtained. A single-surface coating weight of the first material layer was 8 mg/1540 mm².

A positive electrode material (that was, a second material) lithium cobalt oxide, a first material lithium supplementation agent (that was, a first material) lithium iron oxide, a first binder polyvinylidene fluoride, and a first conductive agent conductive carbon black were mixed at a mass ratio of 95:2:1.6:1.4, and N-methylpyrrolidone (NMP) was added as a solvent. The resulting solution was stirred well in a vacuum mixer to obtain a first material layer slurry with a solid content of 75 wt %. The first material layer slurry was uniformly applied on surfaces of both sides of a cathode electrode coated with the protective layers, and drying was performed at 120° C. to obtain a cathode electrode plate with first material layers applied on both surfaces. A single-surface coating weight of the first material layer was 260 mg/1540 mm². In an environment at 25° C., a pressure of 40 t to 80 t was used to compact the cathode electrode plate to a set thickness specification of 84 μm. Then, after cutting and tab welding, a cathode electrode plate with a specification of 74 mm×867 mm was obtained for later use.

### <Preparation of Anode Electrode Plate>

A negative electrode material artificial graphite, silicon carbon, a second binder styrene-butadiene rubber (SBR), and carboxymethyl cellulose (CMC) were mixed at a mass ratio of 87.7:10:1:1.3, and deionized water was then added as a solvent to prepare a slurry with a solid content of 70 wt %. The resulting slurry was stirred well in a vacuum mixer to obtain a second material layer slurry. The second material layer slurry was uniformly applied on one surface of a negative electrode current collector (that was, a second current collector) copper foil with a thickness of 6 m, and drying was performed at 120° C., to obtain a negative electrode with a second material layer applied on a single surface. A single-surface coating weight of the second material layer was 95 mg/1540 mm². Then, the above steps were repeated on the other surface of the copper foil to obtain a negative electrode with second material layers applied on two surfaces. After drying was performed at 120° C., cold pressing, cutting, and tab welding were performed to obtain a negative electrode plate with a specification of 78 mm×875 mm for later use. The second material layers on two surfaces each had a thickness of 93 μm.

### <Preparation of Electrolyte>

In an argon atmosphere glove box with a water content of less than 10 ppm, carbonate compounds ethylene carbonate (EC), propylene carbonate (PC), and diethyl carbonate (DEC) were mixed well at a mass ratio of 10:30:60 to obtain a base solvent. Then, a lithium salt LiPF₆ was added and stirred well to obtain an electrolyte. Based on a total mass of the electrolyte, a mass percentage of the lithium salt LiPF₆ was 12.5%, and the rest was the base solvent.

### <Separator>

A polyethylene porous polymer film with a thickness of 8 μm (manufacturer: Celgard Separator Co., Ltd., USA) was used as a separator.

### <Preparation of Electrochemical Apparatus>

The cathode electrode plate, the separator, and the anode electrode plate were stacked in sequence, so that the separator was located between the cathode electrode plate and the anode electrode plate for isolation. The resulting stack was wound to obtain an electrode assembly. The electrode assembly was placed in an aluminum-plastic film packaging bag, and moisture was removed at 80° C. A prepared electrolyte was injected. Processes such as vacuum packaging, standing, formation, and shaping were performed to obtain an electrochemical apparatus. A formation upper limit voltage was 4.53 V, a formation temperature was 85° C., and a formation time was 45 min to 60 min.

Different from Example 1, in Comparative Example 1, the first current collector was an aluminum foil, and the cathode electrode plate did not include a protective layer or a first material.

Different from Comparative Example 1, in Comparative Example 2, the first current collector included a first conductive layer, a polymer layer, and a second conductive layer.

Different from Comparative Example 1, in Comparative Example 3, the cathode electrode plate included a protective layer.

Different from Comparative Example 1, in Comparative Example 4, the cathode electrode plate included a first material.

Different from Comparative Example 2, in Comparative Example 5, the cathode electrode plate included a first material.

Different from Comparative Example 2, in Comparative Example 6, the cathode electrode plate included a protective layer.

Different from Comparative Example 3, in Comparative Example 7, the cathode electrode plate included a first material.

Different from Example 1, the parameters in Comparative Examples 8 to 12 and Examples 2 to 20 were different. For specific parameter differences, refer to Table 1.

The test methods were as follows:

### Nail Penetration Test

Ten electrochemical apparatuses of examples and comparative examples were taken and fully charged in an environment at 25±3° C. The specific steps were as follows: the electrochemical apparatuses were charged at a constant current of 0.5C to 4.53 V and then charged at a constant voltage of 4.53 V to a cutoff current of 0.05C.

Nail penetration test was performed on the electrochemical apparatuses at 25±3° C. A steel nail with a diameter of 4 mm was used and made of carbon steel, with a taper of 16.5 mm and a total length of 100 mm. A nail penetration speed was set to 30±1 mm/s. A nail penetration depth referred to a depth obtained when the taper of the steel nail passed through the electrochemical apparatus. The state of the electrochemical apparatus during the test was observed. No combustion or explosion of the electrochemical apparatus was used as the criterion for indicating that the electrochemical apparatus passed the nail penetration test. The number of electrochemical apparatuses passed the nail penetration test was recorded. The safety performance of the electrochemical apparatus was evaluated by the pass rate of the nail penetration test. A higher pass rate of the nail penetration test indicated higher safety performance of the electrochemical apparatus. A lower pass rate of the nail penetration test indicated lower safety performance of the electrochemical apparatus.

### Test for the Number of Cycles

At 25° C., the electrochemical apparatus was charged at a constant current of 2C to 4.53 V, then charged at a constant voltage until the current was less than or equal to 0.05C, and then discharged at a constant current of 0.5C to 3 V This was one charge-discharge cycle. A discharge capacity of the first cycle of the electrochemical apparatus was recorded. The electrochemical apparatus was subjected to charge-discharge cycles according to the above method. A discharge capacity of each cycle was recorded until the discharge capacity of the electrochemical apparatus decayed to 80% of the discharge capacity of the first cycle. The number of charge-discharge cycles was recorded.

### Test for Light Transmittance of Cathode Electrode Plate

At a room temperature of 25° C., a double-sided coated and dried cathode electrode plate was placed in a cold press. A compaction pressure was set to be 40 t to 80 t. The electrode plate was compacted in a cold pressing manner to a set target value using a device. This process might undergo different pressures or multiple cold presses and finally reach the set target value of the electrode plate. Three random positions were taken from the cold-pressed double-sided electrode plate. The electrode plate was folded at 180° once. A 5 kg roller was used to naturally roll the folded position. Then, the electrode plate was unfolded at 180°. This process was denoted as one fold. The next fold was performed in a opposite direction at 180°, a 5 kg roller was used to naturally roll the folded position, and the electrode plate was then unfolded at 180°. This process was denoted as two folds. Each electrode plate was repeatedly folded four times, and the number n of light-transmitting points at the folded position of the electrode plate after folded each time was recorded. When n was 0, the electrode plate had no light transmission; when n was 1 to 3, the electrode plate had slight light transmission; when n was greater than or equal to 4, the electrode plate had severe light transmission.

### Test for Piercing of Cathode Electrode Plate

At a room temperature of 25° C., the double-sided coated and dried cathode electrode plate as placed in a cold press. A compaction pressure was set to be 40 t to 80 t. The electrode plate was compacted in a cold pressing manner to a set target value using a device. This process might undergo different pressures or multiple cold presses and finally reach the set target value of the electrode plate. Three random double-sided electrode plates after cold pressing were placed on white paper, red ink was dropped on the electrode plates, and after standing for 4 hours, whether the white paper below the electrode plates was dyed red by the red ink was observed. If at least one piece of white paper of the electrode plates was dyed red, the cathode electrode plate was pierced; otherwise, the cathode electrode plate was not pierced.

### Test for Energy Density of Electrode Assembly

The electrochemical apparatus was placed in a constant-temperature chamber at 25° C. and left standing for 30 minutes, such that the electrochemical apparatus reached a constant temperature. The electrochemical apparatus that had reached the constant temperature was charged at a constant current of 0.5C to a voltage of 4.53 V, then charged at a constant voltage of 4.53 V until the current was 0.05C, and then discharged at 0.5C to a voltage of 3.0 V. The discharge energy was recorded. Energy density of the electrode assembly=discharge energy/(length×width×thickness of the electrochemical apparatus), in Wh/L. The length, width, and thickness all referred to the length, width, and thickness of the packaged electrochemical apparatus.

TABLE 1

| | | | Mass | | | | | |
|---|---|---|---|---|---|---|---|---|
| | First | First | percentage | | Light | | Pass | |
| | conductive | protective | of first | Piercing | transmittance | | rate | |
| | layer | layer | material in | of | of | | of nail | |
| | thickness | thickness | first material | electrode | electrode | Energy | penetration | |
| | H (μm) | B (μm) | layer (C %) | plate | plate | density | test | Cycles |
| Comparative | / | / | / | Not | Slight light | 810.0 | 0/10P | 850 |
| Example 1 | | | | pierced | transmission | | | |
| | | | | | after two folds | | | |
| Comparative | 2 | 1 | 1 | Pierced | No light | 810.0 | 2/10P | 711 |
| Example 2 | | | | | transmission | | | |
| | | | | | after four folds | | | |
| Comparative | 1 | 2 | 1 | Not | Severe light | 801.5 | 10/10P | 833 |
| Example 3 | | | | pierced | transmission | | | |
| | | | | | after three folds | | | |
| Comparative | / | / | 2 | Pierced | Severe light | 826.2 | 0/10P | 740 |
| Example 4 | | | | | transmission | | | |
| | | | | | after one fold | | | |
| Comparative | 2 | / | 2 | Pierced | Severe light | 826.2 | 1/10P | 740 |
| Example 5 | | | | | transmission | | | |
| | | | | | after three folds | | | |
| Comparative | 2 | 2 | / | Not | No light | 801.5 | 10/10P | 838 |
| Example 6 | | | | pierced | transmission | | | |
| | | | | | after four folds | | | |
| Comparative | / | 2 | 2 | Not | Severe light | 813.4 | 10/10P | 860 |
| Example 7 | | | | pierced | transmission | | | |
| | | | | | after two folds | | | |
| Comparative | 1 | 1 | 1 | Pierced | Severe light | 818.1 | 8/10P | 730 |
| Example 8 | | | | | transmission | | | |
| | | | | | after three folds | | | |
| Comparative | 2 | 4.5 | 2.5 | Not | No light | 801.5 | 10/10P | 823 |
| Example 9 | | | | pierced | transmission | | | |
| | | | | | after four folds | | | |
| Comparative | 0.5 | 2 | 2 | Pierced | Severe light | 823.0 | 10/10P | 723 |
| Example 10 | | | | | transmission | | | |
| | | | | | after three folds | | | |
| Comparative | 2 | 0.5 | 2 | Pierced | Slight light | 823.0 | 4/10P | 741 |
| Example 11 | | | | | transmission | | | |
| | | | | | after three folds | | | |
| Comparative | 2 | 4.5 | 2 | Not | No light | 797.4 | 10/10P | 801 |
| Example 12 | | | | pierced | transmission | | | |
| | | | | | after four folds | | | |
| Example 1 | 3 | 4 | 1.5 | Not | No light | 790.2 | 10/10P | 835 |
| | | | | pierced | transmission | | | |
| | | | | | after four folds | | | |
| Example 2 | 2 | 2 | 2 | Not | No light | 813.4 | 10/10P | 876 |
| | | | | pierced | transmission | | | |
| | | | | | after four folds | | | |
| Example 3 | 1 | 2 | 2 | Not | Severe light | 819.8 | 10/10P | 851 |
| | | | | pierced | transmission | | | |
| | | | | | after four folds | | | |
| Example 4 | 1.5 | 2 | 2 | Not | Slight light | 816.6 | 10/10P | 863 |
| | | | | pierced | transmission | | | |
| | | | | | after four folds | | | |
| Example 5 | 2.5 | 2 | 2 | Not | No light | 810.2 | 10/10P | 880 |
| | | | | pierced | transmission | | | |
| | | | | | after four folds | | | |
| Example 6 | 3 | 2 | 2 | Not | No light | 807.0 | 9/10P | 882 |
| | | | | pierced | transmission | | | |
| | | | | | after four folds | | | |
| Example 7 | 4 | 2 | 2 | Not | No light | 800.6 | 8/10P | 883 |
| | | | | pierced | transmission | | | |
| | | | | | after four folds | | | |
| Example 8 | 2 | 1 | 2 | Not | Severe light | 819.8 | 8/10P | 872 |
| | | | | pierced | transmission | | | |
| | | | | | after four folds | | | |
| Example 9 | 2 | 1.5 | 2 | Not | Slight light | 816.6 | 10/10P | 880 |
| | | | | pierced | transmission | | | |
| | | | | | after four folds | | | |
| Example 10 | 2 | 2 | 2 | Not | No light | 813.4 | 10/10P | 876 |
| | | | | pierced | transmission | | | |
| | | | | | after four folds | | | |
| Example 11 | 2 | 2.5 | 2 | Not | No light | 810.2 | 10/10P | 872 |
| | | | | pierced | transmission | | | |
| | | | | | after four folds | | | |
| Example 12 | 2 | 3 | 2 | Not | No light | 807.0 | 10/10P | 863 |
| | | | | pierced | transmission | | | |
| | | | | | after four folds | | | |
| Example 13 | 2 | 4 | 2 | Not | No light | 800.6 | 10/10P | 840 |
| | | | | pierced | transmission | | | |
| | | | | | after four folds | | | |
| Example 14 | 2 | 1 | 0.2 | Not | Slight light | 805.2 | 8/10P | 855 |
| | | | | pierced | transmission | | | |
| | | | | | after four folds | | | |
| Example 15 | 2 | 1 | 0.5 | Not | Slight light | 807.7 | 8/10P | 862 |
| | | | | pierced | transmission | | | |
| | | | | | after four folds | | | |
| Example 16 | 2 | 1 | 1 | Not | Slight light | 811.7 | 8/10P | 872 |
| | | | | pierced | transmission | | | |
| | | | | | after four folds | | | |
| Example 17 | 2 | 1 | 2 | Not | Severe light | 819.8 | 8/10P | 872 |
| | | | | pierced | transmission | | | |
| | | | | | after four folds | | | |
| Example 18 | 2 | 1 | 3 | Not | Severe light | 827.9 | 8/10P | 868 |
| | | | | pierced | transmission | | | |
| | | | | | after three folds | | | |
| Example 19 | 2 | 1 | 4 | Not | Slight light | 836.0 | 7/10P | 836 |
| | | | | pierced | transmission | | | |
| | | | | | after two folds | | | |
| Example 20 | 2 | 1 | 4.5 | Pierced | Slight light | 840.1 | 6/10P | 732 |
| | | | | | transmission | | | |
| | | | | | after one fold | | | |

Referring to Table 1, from the comparison of Comparative Examples 1 to 9 and Example 1, it can be seen that compared to the first current collector being the aluminum foil, the composite current collector can increase the pass rate of the nail penetration test of the electrochemical apparatus 100 and reduce the risk of brittle fracture of the cathode electrode plate. By providing the first material in the cathode electrode plate for lithium supplementation, the energy density of the electrochemical apparatus 100 can be increased. By providing the protective layer on the surface of the cathode current collector (that is, the first current collector), the risk of the cathode electrode plate being pierced can be reduced, and the pass rate of the nail penetration test can be further increased, thereby improving the safety performance of the electrochemical apparatus 100. Therefore, in this application, the first current collector includes the first substrate layer, the first conductive layer, and the second conductive layer. The protective layer is disposed on the surface of the first current collector, and the first material layer includes the first material, which can improve both the energy density and safety performance of the electrochemical apparatus. In addition, compared to Example 1, in Comparative Example 8, when 2/H>B, the pass rate of the nail penetration test is low, and the electrode plate is pierced, indicating that the protective capability of the protective layer on the first current collector is weak. Compared to Example 1, in Comparative Example 9, when B>4, the protective layer is too thick, and the energy density of the electrochemical apparatus 100 is low. In addition, the protective layer being too thick affects electron transport, the impedance of the electrochemical apparatus 100 is high, and the number of cycles of the electrochemical apparatus 100 is small. Therefore, setting 2/H≤B≤4 can improve the protective capability of the protective layer 12 on the first current collector 11, thereby improving the safety performance of the electrochemical apparatus 100 and guaranteeing the energy density and the number of cycles of the electrochemical apparatus 100.

From the comparison of Example 1 and Example 2, it can be seen that when B>2*C, the energy density of the electrochemical apparatus 100 is low. Therefore, setting B≤2*C can increase the energy density of the electrochemical apparatus 100.

From the comparison of Comparative Example 10, Example 2, and Examples 3 to 7, it can be seen that as H increases, the energy density of the electrochemical apparatus gradually decreases, and the pass rate of the nail penetration test gradually decreases. However, when H<1, severe light transmission occurs after three folds, the electrode plate is pierced, and the number of cycles is small. When H>3, the pass rate of the nail penetration test is low. Therefore, setting 1≤H can reduce the risk of the cathode electrode plate being pierced and brittle fracture, help to reduce lithium precipitation in the electrochemical apparatus, and extend the service life of the electrochemical apparatus 100. Setting H≤3 helps to increase the energy density of the electrochemical apparatus 100 and improve the safety performance of the electrochemical apparatus.

Further, setting 1.5≤H can further reduce the risk of the cathode electrode plate being pierced during cold pressing, help to reduce lithium precipitation in the electrochemical apparatus, and further extend the service life of the electrochemical apparatus 100. Setting H≤2 helps to further increase the energy density and improve the safety performance of the electrochemical apparatus 100.

From the comparison of Comparative Example 11, Example 2, and Examples 8 to 13, it can be seen that as B increases, the energy density of the electrochemical apparatus gradually decreases, while the pass rate of the nail penetration test gradually increases. When B>4 or B<1, the number of cycles of the electrochemical apparatus is small. Therefore, setting B≥1 can increase the pass rate of the nail penetration test, thereby improving the safety performance of the electrochemical apparatus and extending the service life. Setting B≤4 helps to increase the energy density of the electrochemical apparatus and extend the service life.

Further, setting 1.5≤B can further increase the pass rate of the nail penetration test, thereby improving the safety performance of the electrochemical apparatus and further extending the service life. Setting B≤2.5 helps to further increase the energy density of the electrochemical apparatus.

From the comparison of Comparative Example 12 and Examples 14 to 20, it can be seen that as the percentage C % of the first material in the first material layer increases, the energy density of the electrochemical apparatus gradually increases, and the light transmittance of the cathode electrode plate also gradually increases. When C %<0.5%, the number of cycles is small. When C %>4%, the number of cycles is small, and the pass rate of the nail penetration test is low. Therefore, setting C %≥0.5% helps to increase the energy density of the electrochemical apparatus and extend the service life of the electrochemical apparatus. Setting C %≤4% helps to reduce the risk of the cathode electrode plate being pierced and brittle fracture, reduce side reactions with the electrolyte, extend the service life of the electrochemical apparatus, and improve the safety performance of the electrochemical apparatus.

Further, setting C %≥1% helps to further increase the energy density of the electrochemical apparatus and further extend the service life of the electrochemical apparatus. Setting C %≤3% helps to further reduce the risk of the cathode electrode plate being pierced and brittle fracture and further improve the safety performance of the electrochemical apparatus.

The above disclosed are only preferred embodiments of this application. Certainly, they cannot be used to limit the scope of rights of this application. Therefore, equivalent changes made according to the claims of this application still fall within the scope covered by this application.

What is claimed is:

1. An electrochemical apparatus, comprising an electrode assembly; wherein the electrode assembly comprises a cathode electrode plate, a separator, and an anode electrode plate; the separator is disposed between the cathode electrode plate and the anode electrode plate; and the anode electrode plate comprises silicon element;
the cathode electrode plate comprises a first current collector, a protective layer, and a first material layer; wherein along a thickness direction of the electrode assembly, the protective layer is disposed on a surface of the first current collector, and the first material layer is disposed on a surface of the protective layer facing away from the first current collector;
the first current collector comprises a first substrate layer, a first conductive layer, and a second conductive layer; wherein the first substrate layer is disposed between the first conductive layer and the second conductive layer; and the first substrate layer comprises at least one of polyethylene terephthalate, polyimide, polyamide, polyurethane, polyethylene, or polypropylene;
the first material layer comprises a first material and a second material, the first material comprising lithium element; and
each of the first conductive layer and the second conductive layer has a thickness of H micrometers, and the protective layer has a thickness of B micrometers, wherein 2/H≤B≤4.

2. The electrochemical apparatus according to claim 1, wherein the first material comprises at least one of Li₅₋ₓFeO_{4-y}, Li₆₋ₓCoO_{4-y}, Li_{2-z}—MnO₂, or Li_{1.2-r}Ni_{0.13}Fe_{0.13}Mn_{0.54}O₂, wherein 4≤x≤5, 2≤y≤4, 1.6≤z≤2, and 0.2≤r≤1.2; a mass percentage of the first material in the first material layer is C %, and B≤2*C.

3. The electrochemical apparatus according to claim 1, wherein 1≤H≤3.

4. The electrochemical apparatus according to claim 3, wherein 1.5≤H≤2.

5. The electrochemical apparatus according to claim 1, wherein 1≤B≤4.

6. The electrochemical apparatus according to claim 5, wherein 1.5≤B≤2.5.

7. The electrochemical apparatus according to claim 2, wherein 0.5%≤C %≤4%.

8. The electrochemical apparatus according to claim 7, wherein 1%≤C %≤3%.

9. The electrochemical apparatus according to claim 1, wherein
along the thickness direction of the electrode assembly, the protective layer is disposed on each of two opposite surfaces of the first current collector, and the first material layer is disposed on the surface of the protective layer facing away from the first current collector.

10. The electrochemical apparatus according to claim 1, wherein
the second material comprises at least one of lithium cobalt oxide, lithium nickel cobalt manganese oxide, lithium nickel cobalt aluminum oxide, lithium iron phosphate, or lithium manganese oxide.

11. The electrochemical apparatus according to claim 1, wherein
the protective layer comprises an inorganic material, a conductive agent, and a binder.

12. The electrochemical apparatus according to claim 11, wherein
the binder comprises at least one of metal polyacrylate, polyvinylidene fluoride, or styrene-butadiene rubber.

13. The electrochemical apparatus according to claim 11, wherein
the inorganic material comprises at least one of aluminum oxide, boehmite, titanium dioxide, barium titanate, or barium sulfate.

14. The electrochemical apparatus according to claim 1, wherein
the anode electrode plate comprises a second current collector and a second material layer, the second material layer is disposed on at least one surface of the second current collector, the second material layer comprises silicon element, a mass percentage of silicon element in the second material layer is D %, and 1%≤D %≤50%.

15. The electrochemical apparatus according to claim 1, wherein
a specific charge capacity of the first material is E, a specific charge capacity of the second material is F, and F<E.

16. The electrochemical apparatus according to claim 15, wherein
240 mAh/g≤E≤950 mAh/g.

17. An electronic device, comprising an electrochemical apparatus, and the electrochemical apparatus comprises an electrode assembly; wherein the electrode assembly comprises a cathode electrode plate, a separator, and an anode electrode plate; the separator is disposed between the cathode electrode plate and the anode electrode plate; and the anode electrode plate comprises silicon element;
the cathode electrode plate comprises a first current collector, a protective layer, and a first material layer, wherein along a thickness direction of the electrode assembly, the protective layer is disposed on a surface of the first current collector, and the first material layer is disposed on a surface of the protective layer facing away from the first current collector;
the first current collector comprises a first substrate layer, a first conductive layer, and a second conductive layer; wherein the first substrate layer is disposed between the first conductive layer and the second conductive layer; and the first substrate layer comprises at least one of polyethylene terephthalate, polyimide, polyamide, polyurethane, polyethylene, or polypropylene;
the first material layer comprises a first material and a second material, the first material comprising lithium element; and
each of the first conductive layer and the second conductive layer has a thickness of H micrometers, and the protective layer has a thickness of B micrometers, wherein 2/H≤B≤4.

18. The electronic device according to claim 17, wherein the first material comprises at least one of Li₅₋ₓFeO_{4-y}, Li₆₋ₓCoO_{4-y}, Li_{2-z}MnO₂, or Li_{1.2-r}Ni_{0.13}Fe_{0.13}Mn_{0.54}O₂, wherein 4≤x≤5, 2≤y≤4, 1.6≤z≤2, and 0.2≤r≤1.2; a mass percentage of the first material in the first material layer is C %, and B≤2*C.

19. The electronic device according to claim 17, wherein 1≤H≤3, and/or, 1≤B≤4.

20. The electronic device according to claim 18, wherein 0.5%≤C %≤4%.
